(19) United States
(12) Patent Application Publication
(10) Pub. No.: US 2026/0121321 A1
(43) Pub. Date: Apr. 30, 2026

(54) INFORMATION HANDLING SYSTEM CABLE PORT WITH SIDE WALL BRACKET

(71) Applicant: Dell Products L.P., Round Rock, TX (US)

(72) Inventors: Chin-Chung Wu, New Taipei City (TW); Che-Jung Chang, Taipei (TW); Chih-Hao Lu, New Taipei City (TW); Fong-An Kan, New Taipei City (TW); Yueh-Ching Lu, Teipei City (TW)

(73) Assignee: Dell Products L.P., Round Rock, TX (US)

(21) Appl. No.: 18/930,201

(22) Filed: Oct. 29, 2024

(51) Int. Cl. H01R 12/72; G06F 1/16; H01R 13/6581

(52) U.S. Cl. CPC H01R 12/722; G06F 1/1633; H01R 13/6581

(57) ABSTRACT

An information handling system USB Type C port couples to a circuit board to communicate between processing components of the information handling system and a cable having a USB Type C connector. A tongue assembly in the port has a bracket coupled to an upper surface with arms that extend along the side of the tongue assembly to a front side where the cable connector inserts. The arms have a height of greater than the height of cable connector snap members that engage the arms to hold the cable connector in place with in the port.

### BACKGROUND OF THE INVENTION

### Field of the Invention

The present invention relates in general to the field of information handling system communication ports, and more particularly to an information handling system cable port with side wall bracket.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with a central processing unit (CPU) that executes instructions in cooperation with a memory that stores the instructions and information. Desktop and other types of stationary information handling system generally have a housing that operates from a fixed position with external power and peripheral devices, such as a keyboard, mouse and display. Portable information handling systems integrate processing components, a display and a power source in a portable housing to support mobile operations. Portable information handling systems allow end users to carry a system between meetings, during travel, and between home and office locations so that an end user has access to processing capabilities while mobile. Portable information handling systems will also typically operate in a fixed location with external power and peripheral devices. In some instances, portable information handling systems interact with power and peripheral devices through a docking station that offers a single convenient cable interface to access power and peripheral devices in a desktop area. In an enterprise scenario, an end user selects a cube or other work area, plugs into the docking station, and has full access to the resources in the working area.

To support power and information communication through a single cable connection, industry has developed the USB Type C standards that transfer 100 W of power and 40 GB/s of information transfer. A USB Type C connector and port have a minimalist footprint that conveniently couple in a reversible manner. One difficulty with the minimal footprint is that frequent usage of a USB Type C port in an information handling system can wear the port so that the USB connection tends to lose reliability and stability over time. Conventional USB Type C ports have a tongue terminal with a middle plastic structure that is structurally constrained by minimal space in the port. Once the tongue terminal wears, it can introduce shorts and loss of function across the conductive terminals that couple to the tongue terminal. When a USB Type C port fails, repairs tend to be expensive and can include replacement of the system motherboard.

### SUMMARY OF THE INVENTION

Therefore, a need has arisen for a system and method which offers a cable port having increased usage cycles, reliability and stability.

In accordance with the present invention, a system and method are provided which substantially reduce the disadvantages and problems associated with previous methods and systems for interfacing a cable with a port. A bracket coupled to a tongue assembly extends metal arms on opposing sides of the tongue assembly to accept a snap connector member of a port connector.

More specifically, an information handling system processes information with a processor that executes instructions in cooperation with a memory that stores the instructions and information. A Type C USB port couples to a circuit board and interfaces with the processor to interface with external devices through a cable having a Type C USB connector. The cable port has a tongue assembly with upper and lower interface pins and a bracket that extends arms from a rear side to a front side of the tongue assembly at opposing sides of the tongue assembly. When a connector inserts in the port, snap connector members align with the arms and couple in place at an indent formed in the arms. The arms having a height of greater than the height of the snap connector members so that insert and removal work against metal of the arms instead of plastic of the tongue assembly.

The present invention provides a number of important technical advantages. One example of an important technical advantage is that a Type C USB port has a metal side surface where a Type C USB connector inserts to couple in place with a snap connector member. The metal surface offers a firm end user feedback with a click when the connector couples in place and reduces port wear over insertion and removal cycles of the connector. The result is a more robust port that lasts through more insertion and removal cycles, a more stable connection and improved signal reliability.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exploded front perspective view of an information handling system having USB Type C ports;

FIG. 2 depicts an upper perspective view of a Type C USB port having a port coupling structure to couple with a USB connector;

FIG. 3 depicts a side perspective exploded view of the USB Type C port assembly to include arms that manage connector insertions; and

FIG. 4 depicts a side perspective transparent view of the Type C USB port accepting a snap connector member of a Type C USB connector.

### DETAILED DESCRIPTION

An information handling system USB Type C cable port couples to a cable connector in robust and stable manner with arms along a tongue assembly engaging snap members of a cable connector. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

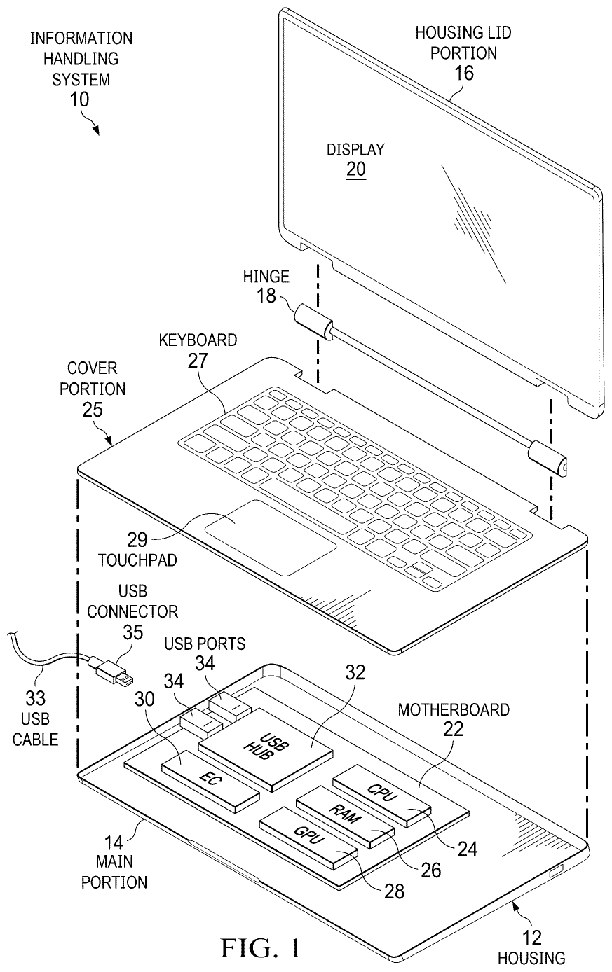

Referring now to FIG. 1, an exploded front perspective view depicts an information handling system 10 having USB Type C ports 34. In the example embodiment, information handling system 10 has a portable housing 12 with a main portion 14 rotationally coupled to lid portion 16 by a hinge 18. Information is presented as visual images at a display 20 coupled in a housing lid portion 16. A motherboard 22 coupled in housing main portion 14 interfaces processing components that cooperate to process information. A central processing unit (CPU) 24 executes instructions to process the information in cooperation with a random access memory (RAM) 26 that stores the instructions and information. A graphics processing unit (GPU) 28 interfaces with CPU 24 to further process information into pixel values that define images presented at display 20. An embedded controller (EC) 30 manages the processing component operations on a physical level, such as the application of power, maintaining thermal constraints, and supporting interactions with peripheral devices like a keyboard, mouse, and camera. For instance, information and power can be communicated and sent from EC 30 to peripheral devices through a USB hub 32, USB ports 34, USB cable connector 35 and USB cable 33. Alternatively, information and power can be communicated and sent from peripheral devices to EC 30 through the USB cable 33, USB cable connector 35, USB hub 32 and USB ports 34. A housing cover portion 25 couples over main portion 14 to enclose the processing components and support an integrated keyboard 27 and touchpad 29 that accept end user inputs. Although the example embodiment depicts a portable information handling system configuration, in alternative embodiments a desktop or other type of stationary information handling system may be used.

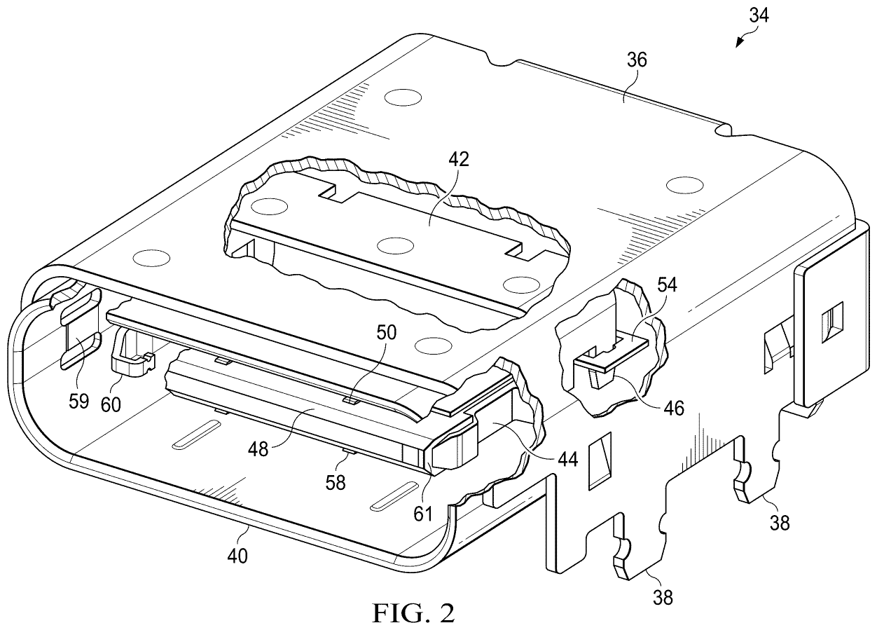

Referring now to FIG. 2, an upper perspective view depicts a Type C USB port 34 having a port coupling structure to couple with a USB connector. The top and side portions of a cover 36 couples port 34 to a circuit board with extensions 38 directed downward from a bottom surface of the port. A shield 40 couples within cover 36 to surround communication interfaces and shield noise that might interfere with signal transmission. For instance, cover 36 and shield 40 are formed from steel and grounded to a system ground through a circuit board that couples by extensions 38. Portions of cover 36 and shield 40 are depicted as transparent to illustrate internal components of port 34. Although the example embodiment depicts a USB Type C port, in alternative embodiments other types of communication ports.

A tongue assembly within shield 40 has a plurality of upper interface pins 50 and a plurality of lower interface pins 58 that interface with a cable connector when the cable connector inserts through the front of port 34 to communicate information, power and ground. The upper interface pins 50 couple to an upper tongue portion 48 of plastic and are separated from the lower interface pins 58 by metal planar member 54, which suppresses EMI between the upper and lower portions of the tongue assembly. A metal bracket 42, such as steel, couples across an upper surface of the tongue assembly and is fixed to the shield by laser sintering, welding or other technique that provides a conductive bond to share ground. Metal bracket 42 bends at each opposing side so that an extension 46 inserts through an opening of planar portion 54 to share ground. In addition, metal bracket 42 has an arm 44 on each opposing side that extends forward to a front side of tongue upper portion 48. In the example embodiment, a guide 61 is formed at each opposing front side of tongue upper portion 48 so that an end 60 of arm 44 inserts in the guide to provide a robust structure with the metal material of arm 44 exposed along the sides and at the front of upper tongue portion 48.

In operation, a USB Type C cable connector inserts into the front opening of port 34 to establish signal, power and ground communication. An extension 59 on each side of shield 40 guides the cable connector insertion to align upper interface pins 50 with upper pins of the connector and lower interface pins 58 with lower pins of the connector. The upper tongue portion 48 mates with a matching portion of the connector to maintain the alignment of the interface pins as the connector fully inserts into port 34 and against shield 40. During the insertion, the plastic material of the tongue assembly is protected from excessive wear with the metal material of arms 44 and their ends 60 with a firm insertion click as feedback to the end user. In particular, as is shown in greater detail below, arm 44 has a height at the side of the tongue assembly that exceeds the height of cable connector insertion snaps so that cable insertion wears at the metal of arm 44 without contacting the tongue assembly along the sides.

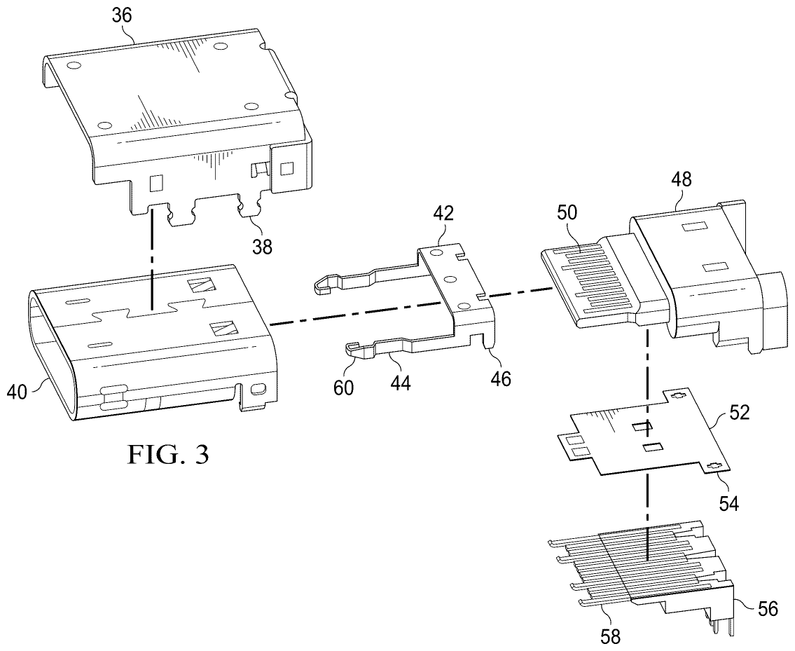

Referring now to FIG. 3, a side perspective exploded view depicts the USB Type C port 34 assembly to include arms 44 that manage connector insertions. Planar portion 52 is cut from sheet metal, such as steel, to have the footprint of the interface pins 50 and 58 and an opening 54 on each of opposing sides at the port rear. The planar metal footprint grounds to manage signal interference between upper interface pins 50 and lower interface pins 58. Upper tongue portion with upper interface pins 50 assembles to lower tongue portion 56 with lower interface pins 58 to capture planar portion 52 in a middle position. A metal bracket 42 couples over upper tongue portion 48 so that an extension 46 on each opposing side of bracket 42 inserts into the openings 54 of planar portion 52. To ensure a good signal integrity, a metal shield 40 couples around the tongue assembly of upper tongue portion 48, planar portion 52, lower tongue portion 56 and bracket 42. Ground is provided by laser sintering or welding bracket 42 to shield 40. A cover 36 couples to the top of shield 40 with extensions 38 inserted into a circuit board and interfaced with ground.

Metal bracket 42 couples to the upper tongue portion 48 so that first and second arms 44 extend forward to the front of the port assembly and ends 60 wrap around the front of the tongue assembly. Arms 44 are shaped at a midsection to form an indent that accepts a snap connector of a Type C USB connector to hold the connector in the port assembly. Arms 44 have a vertical height that is greater than the height of the connector snaps so that insertion and removal of the connector has the snap work against the metal of the arm instead of the plastic of the tongue assembly. The metal coupling surface of arms 44 help to reduce wear in the port assembly, to ensure a stable physical connection and to provide a robust life expectancy for the port so that replacements of the port at an information handling system circuit board are avoided. The end 60 wraps around the tongue assembly front end so that any attempt to force an insertion of an incorrect connector type will act against the metal instead of wearing the tongue assembly front end.

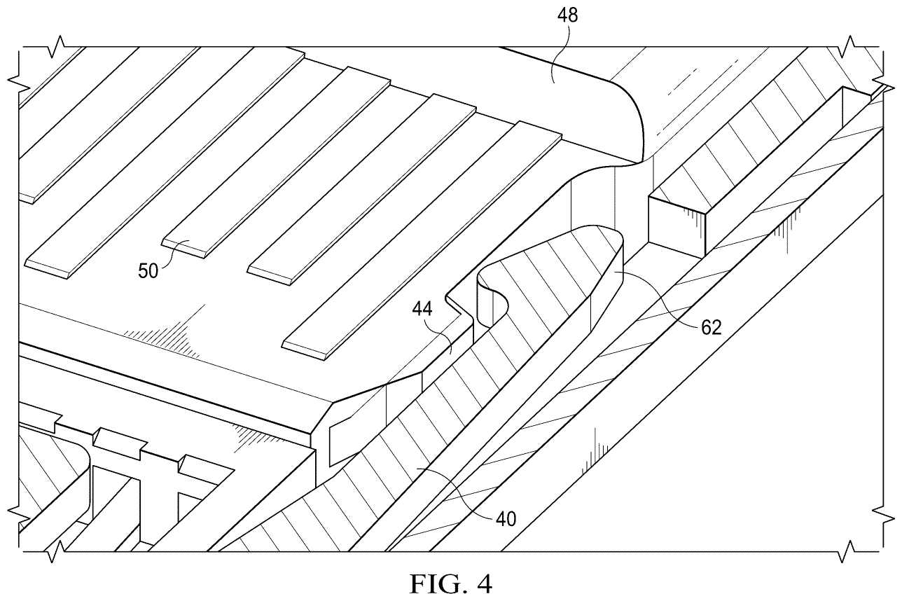

Referring now to FIG. 4, a side perspective transparent view depicts the Type C USB port accepting a snap connector member 62 of a Type C USB connector. The USB plug side snap connector member 62 inserts around the indentation in arm 44 and compresses to hold the connector in place in the port within shield 40. The height of snap connector member 62 is less than the height of arm 44 so that the snap connector member works against the metal of arm 44 during insertion and removal to reduce wear at the tongue assembly upper tongue portion 48. The reduced wear helps to ensure correct interface pin 50 alignment with the connector interface pins and provides a positive feedback to the end user with a click against the metal when the connector is fully inserted.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a circuit board coupled in the housing;
a processor coupled to the circuit board and operable to execute instructions that process information;
a memory coupled to the circuit board and interfaced with the processor, the memory operable to store the instructions and information; and
a cable port coupled to the circuit board and interfaced with the processor, the cable port having a first set of conductive pins coupled to an upper tongue portion and interfaced with the circuit board, a second set of conductive pins coupled to a lower tongue portion and interfaced with the circuit board, a planar portion coupled between the upper tongue portion and lower tongue portion and a bracket having a central member extending across the upper tongue portion to insert at opposing sides in the planar portion, a first arm extending along a first side of the upper tongue portion to bend around a front side of the upper tongue portion and a second arm extending along a second side of the upper tongue portion to bend around the front side of the upper tongue portion.

2. The information handling system of claim 1 further comprising:
a shield coupled around the upper tongue portion and lower tongue portion; and
first and second rectangular extensions formed in opposing sides of the shield at the front side of the upper tongue portion to define a guide to accept a cable connector.

3. The information handling system of claim 2 further comprising plural laser spot welds at the bracket central portion to couple with the shield.

4. The information handling system of claim 3 further comprising a cover coupled over the shield and having extensions at a bottom side that engage with the circuit board.

5. The information handling system of claim 4 wherein the first and second sets of conductive pins are configured as a USB Type C interface.

6. The information handling system of claim 3 further comprising a cable connector having first and second snap arms that align on insertion into the cable port with the first and second bracket arms.

7. The information handling system of claim 6 wherein the first and second bracket arms have a height of greater than the first and second snap arms.

8. The information handling system of claim 7 wherein the bracket and shield are formed from steel.

9. The information handling system of claim 8 wherein the bracket first and second arms insert into a guide formed at a front side of the upper tongue portion.

10. A method for assembling of a cable port, the method comprising:
securing a planar portion between a lower tongue portion having a first plurality of conductive pins and an upper tongue portion having a second plurality of conductive pins;
coupling a bracket over the upper tongue portion and into the planar portion with a tab extending through a hole formed in the planar portion;
extending a first arm of the bracket along a first side of the upper tongue portion to a front side of the upper tongue portion;
extending a second arm of the bracket along a second side of the upper tongue portion to a front side of the upper tongue portion; and
securing the planar portion, the lower tongue portion, the upper tongue portion, and the bracket within a shield.

11. The method of claim 10 further comprising laser spot welding the bracket to the shield.

12. The method of claim 10 further comprising:
forming a first guide and second guide on opposing sides of the upper tongue portion at the front side;
inserting the first arm into the first guide at the front side; and
inserting the second arm into the second guide at the front side.

13. The method of claim 12 further comprising forming first and second rectangular extensions on the shield proximate the front side to align a cable connector with the first and second plurality of pins.

14. The method of claim 10 wherein the first arm and second arm have a height of greater than a height of a cable connector snap arm that engages the upper tongue portion at insertion of a cable connector in the cable port.

15. The method of claim 14 wherein the cable port and cable connector interface with a USB Type C configuration.

16. A cable port configured to couple to a circuit board, the cable port comprising:
a first set of conductive pins coupled to an upper tongue portion;
a second set of conductive pins coupled to a lower tongue portion;
a planar portion coupled between the upper tongue portion and lower tongue portion; and
a bracket having a central member extending across the upper tongue portion to insert at opposing sides in the planar portion, a first arm extending along a first side of the upper tongue portion to bend around a front side of the upper tongue portion and a second arm extending along a second side of the upper tongue portion to bend around the front side of the upper tongue portion.

17. The cable port of claim 16 further comprising:
a guide formed in opposing sides at the front side of the upper tongue portion;
wherein the first and second arms insert into the guide at the front side of the upper tongue portion.

18. The cable port of claim 17 wherein the first and second arms have a height of greater than a height of snap members of a cable connector that couples to the upper tongue portion.

19. The cable port of claim 18 further comprising:
a shield coupled around the upper tongue portion and lower tongue portion; and
first and second rectangular extensions formed in opposing sides of the shield at the front side of the upper tongue portion to define a guide to accept a cable connector.

20. The cable port of claim 19 further comprising a cover coupled over the shield and having extensions at a bottom side that engage with the circuit board.
